(19) United States
(12) Patent Application Publication
(10) Pub. No.: US 2026/0253366 A1
(43) Pub. Date: Aug. 27, 2026

(54) Grid Filter for Images of Multiple Items

(71) Applicant: eBay Inc., San Jose, CA (US)

(72) Inventor: Yogesh Yashwant Patil, Davis, CA (US)

(73) Assignee: eBay Inc., San Jose, CA (US)

(21) Appl. No.: 19/060,436

(22) Filed: Feb. 21, 2025

(51) Int. Cl. G06V 10/26; G06V 10/24; G06V 10/74; H04N 23/60; H04N 23/63

(52) U.S. Cl. CPC G06V 10/26; G06V 10/245; G06V 10/761; H04N 23/632; H04N 23/635; H04N 23/64

(57) ABSTRACT

Grid filter for images of multiple items is described. A computing device obtains a selection of a grid filter including a set of segments of a grid filter including a set of segments to apply to an image of a set of items. The set of items is associated with a same item category. The method segments the image of the set of items into respective image segments of the set of items. Respective items of the set of items align with respective segments of the set of segments. The computing device generates at least one item listing for the set of items, where the at least one item listing includes at least one image segment of the respective image segments.

### BACKGROUND

A computing devices can implement various techniques for obtaining and processing data. A computing device may include one or more sensors for capturing the data. Additionally, or alternatively, the computing device may receive the data from another device or as input via a user interface.

The computing device may utilize machine learning and/or artificial intelligence techniques to generate information from the data. The computing device can implement one or more learning models, such as artificial intelligence models and/or machine learning models, to capture patterns and relationships in the data, enabling the models to make predictions or decisions on new, unseen data.

### SUMMARY

A computing device obtains a selection of a grid filter to apply to an image. For example, the computing device receives an indication of the grid filter (e.g., from another device or from input). In some other examples, the computing device selects the grid filter from a list of grid filters according to a threshold image resolution and/or one or more capabilities of the computing device. The computing device may apply the grid filter to a live camera feed and/or to an image, such that the grid filter overlays the live camera feed and/or the image. If items in the live camera feed align with segments of the grid filter, then the computing device may capture an image of the items. The computing device may segment the image into respective image segments, where each image segment includes a single item. The computing device may provide the respective image segments as input to a learning model, and the learning model may generate one or more item listings for the items in the image.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ techniques described herein.

FIGS. 2 and 3 depict examples of user interfaces for generating a single listing for items in an image based on a grid filter.

FIG. 4 depicts an example of a user interface for generating multiple listings for items in an image based on a grid filter.

FIGS. 5 through 7 depict procedures in example implementations of a grid filter for images of multiple items.

FIG. 8 illustrates an example of a system that includes an example computing device that is representative of one or more computing systems and/or devices that may implement the various techniques described herein.

### DETAILED DESCRIPTION

### Overview

Techniques for listing items based on a grid filter are described. A computing device obtains a grid filter to apply to an image of multiple items. The computing device uses the grid filter to segment the image into respective image segments, where each image segment includes an item. The computing device can use the image segments and a learning model to generate listings for items in the image segments. For example, the computing device can generate a single listing if the items are within a threshold similarity or can generate multiple listings if the items are not within the threshold similarity.

Conventionally, a user may manually generate item listings by providing characteristics and other information related to the item via input to a computing device. The process for listing an item may include the computing device prompting the user to provide input to capture multiple images of each item to be listed. The computing device may compress the images of each item for storage at a server system (e.g., to reduce signaling overhead and to reduce memory usage at the server system). The server system and/or the computing device access the stored, compressed images of the items to publish the item listing using the compressed images. The conventional techniques for manually generating individual item listings (e.g., using one image or picture for each item) leads to increased use of computer resources, including memory and processing resources, to capture, process, and compress individual images of items. Additionally, or alternatively, a computing device compressing individual images for each item to be listed can lead to inefficient use of processing resources at the computing device. For example, the computing device may include a high-resolution camera capable of capturing detailed images, but compressing the images for storage and transmission may not leverage the advanced imaging capabilities of the computing device.

As described herein, to reduce the use of computational resources related to automatically generating item listings, as well as to leverage the advanced imaging capabilities of a computing device, the computing device obtains (e.g., selects, receives a selection of) a grid filter to apply to an image of multiple items. A grid filter includes a pattern of segments or cells that can be applied to an image or live camera feed to organize and align multiple items within an image frame. In some cases, the computing device can select the grid filter to satisfy capabilities of the computing device and image resolution thresholds (e.g., minimums, criteria) for generating one or more listings of the items. The computing device segments (e.g., divides, partitions) the image into respective image segments using the grid filter. For example, the computing devices overlays the grid filter onto the image and divides the image along the grid lines to create separate image segments, each image segment including an individual item. The computing device uses image processing techniques such as edge detection, segmentation, thresholding, and contour analysis to detect items and corresponding grid boundaries for image segments. The computing device implements (e.g., uses, deploys) a learning model to generate one or more item listings using the image segments as input. For example, the computing device may provide the image and/or image segments as input to the learning model, and the learning model may generate a single listing if the items are the same or multiple listings if the items are different. The learning model may be trained to identify characteristics of items in respective image segments, such as color, shape, size, brand, or condition, and then populate corresponding fields in an item listing with the identified characteristics.

By implementing a grid filter to capture an image of multiple items, a computing device may reduce the computational resources for listing generation and management. For example, without a grid filter to ensure items align with grid segments, the quality and consistency of item placement within images may vary, reducing the accuracy of a learning model in identifying and categorizing items. Additionally, or alternatively, if a computing device obtains individual images of respective items, then the computing device may manage and organize numerous individual images and their associated metadata. This could lead to increased complexity in data management and scalability issues as the number of items grows. Additionally, or alternatively, the grid filter technique may allow for more efficient use of storage resources by capturing multiple items in a single high-resolution image rather than storing numerous individual images. The structured approach of using a grid filter may also facilitate easier scaling of the listing process as the number of items increases, improving the overall efficiency of large-scale listing operations.

In some aspects, the techniques described herein relate to a computer-implemented method including obtaining, at a computing device, a selection of a grid filter including a set of segments to apply to an image of a set of items, where the set of items is associated with a same item category, segmenting, based on the grid filter, the image of the set of items into respective image segments of the set of items, where respective items of the set of items align with respective segments of the set of segments, and generating at least one item listing for the set of items, where the at least one item listing includes at least one image segment of the respective image segments.

In some aspects, the techniques described herein relate to a computer-implemented method, where obtaining the selection of the grid filter includes receiving (e.g., obtaining, detecting), via a user interface of the computing device, input that indicates the selection of the grid filter.

In some aspects, the techniques described herein relate to a computer-implemented method, where obtaining the selection of the grid filter includes receiving, from an application server, a set of grid filters, and selecting, based on an image resolution capability associated with the computing device and a threshold image resolution associated with the at least one item listing, the grid filter from the set of grid filters.

In some aspects, the techniques described herein relate to a computer-implemented method, further including receiving, at the computing device, a live image feed of the set of items, displaying, via a user interface of the computing device, the grid filter over the live image feed of the set of items, and capturing, at the computing device, the image of the set of items based on the set of items aligning (e.g., being within) with the respective segments of the set of segments, where the respective segments of the set of segments correspond to the respective image segments of the set of items.

In some aspects, the techniques described herein relate to a computer-implemented method, further including displaying, via the user interface, feedback that indicates at least one item of the set of items fails to align with the respective segments of the set of segments.

In some aspects, the techniques described herein relate to a computer-implemented method, further including receiving, at the computing device, the image of the set of items, and displaying, via a user interface of the computing device, the grid filter over the image of the set of items, where segmenting the image of the set of items is responsive to the set of items aligning with the respective segments of the set of segments, and where the respective segments of the set of segments correspond to the respective image segments of the set of items.

In some aspects, the techniques described herein relate to a computer-implemented method, where generating the at least one item listing includes receiving, as output from a learning model and based on providing the image of the set of items as input to the learning model, one or more respective characteristics of the set of items and a measure of similarity between the one or more respective characteristics (e.g., attributes, features), and generating, based on the measure of similarity between the one or more respective characteristics satisfying one or more threshold values, a single item listing for the set of items or respective item listings for the set of items, where one or more fields of the at least one item listing include the one or more respective characteristics of the set of items.

In some aspects, the techniques described herein relate to a computer-implemented method, further including applying, based on a processing capability of the computing device and prior to generating the at least one item listing for the set of items, one or more image filters to the respective image segments, where the one or more image filters correct the respective image segments.

In some aspects, the techniques described herein relate to a computer-implemented method, further including transmitting, based on a resolution of the image of the set of items, at least one of the respective image segments, the image of the set of items, or an indication of the grid filter to an application server for storage.

In some aspects, the techniques described herein relate to a computer-implemented method, further including publishing, responsive to generating the at least one item listing, the at least one item listing via an application server.

In some aspects, the techniques described herein relate to a computer-implemented method, where a numerical quantity (e.g., number, amount) of segments of the set of segments is based on an image resolution capability associated with the computing device and a threshold image resolution associated with the respective image segments.

In some aspects, the techniques described herein relate to a system including one or more processors, and a computer-readable storage medium storing instructions that are executable by the one or more processors to perform operations including obtaining a selection of a grid filter including a set of segments to apply to an image of a set of items, where the set of items is associated with a same item category, segmenting, based on the grid filter, the image of the set of items into respective image segments of the set of items, where respective items of the set of items align with respective segments of the set of segments, and generating at least one item listing for the set of items, where the at least one item listing includes at least one image segment of the respective image segments.

In some aspects, the techniques described herein relate to a computer-implemented method including transmitting, to a computing device, a set of grid filters to apply to an image of a set of items, transmitting, based on transmitting the set of grid filters to the computing device, instructions to cause the computing device to select a grid filter from the set of grid filters, where a numerical quantity of segments of the grid filter is based on an image resolution capability associated with the computing device and a threshold image resolution associated with the image of the set of items, and receiving, from the computing device and based on respective image segments of the image of the set of items, at least one item listing for the set of items where respective items of the set of items align with respective segments of a set of segments of the grid filter, and where the at least one item listing includes at least one image segment of the respective image segments.

In some aspects, the techniques described herein relate to a computer-implemented method, further including selecting the set of grid filters based on the threshold image resolution, where the threshold image resolution is associated with one or more of an image resolution capability associated with a learning model to generate the at least one item listing or a minimum resolution associated with the at least one item listing.

In some aspects, the techniques described herein relate to a computer-implemented method, further including transmitting additional instructions to cause the computing device to display, via a user interface of the computing device, the grid filter over a live image feed of the set of items, where the image of the set of items is based on the set of items aligning with the respective segments of the set of segments, and where the respective segments of the set of segments correspond to the respective image segments of the set of items.

In some aspects, the techniques described herein relate to a computer-implemented method, further including transmitting additional instructions to cause the computing device to display, via a user interface of the computing device, feedback that indicates at least one item of the set of items fails to align with the respective segments of the set of segments.

In some aspects, the techniques described herein relate to a computer-implemented method, further including transmitting, to the computing device, the image of the set of items, where the set of items align with the respective segments of the set of segments, and where the respective segments of the set of segments correspond to the respective image segments of the set of items.

In some aspects, the techniques described herein relate to a computer-implemented method, where receiving the at least one item listing is based on a measure of similarity between one or more respective characteristics of the set of items satisfying one or more threshold values, where the at least one item listing includes a single item listing for the set of items or respective item listings for the set of items, and where one or more fields of the at least one item listing include the one or more respective characteristics of the set of items.

In some aspects, the techniques described herein relate to a computer-implemented method, further including receiving, from the computing device and based on a resolution of the image of the set of items, at least one of the respective image segments, the image of the set of items, or an indication of the grid filter, and storing the at least one of the respective image segments, the image of the set of items, or the indication of the grid filter.

In some aspects, the techniques described herein relate to a computer-implemented method, further including publishing, responsive to receiving the at least one item listing, the at least one item listing.

### Example of an Environment

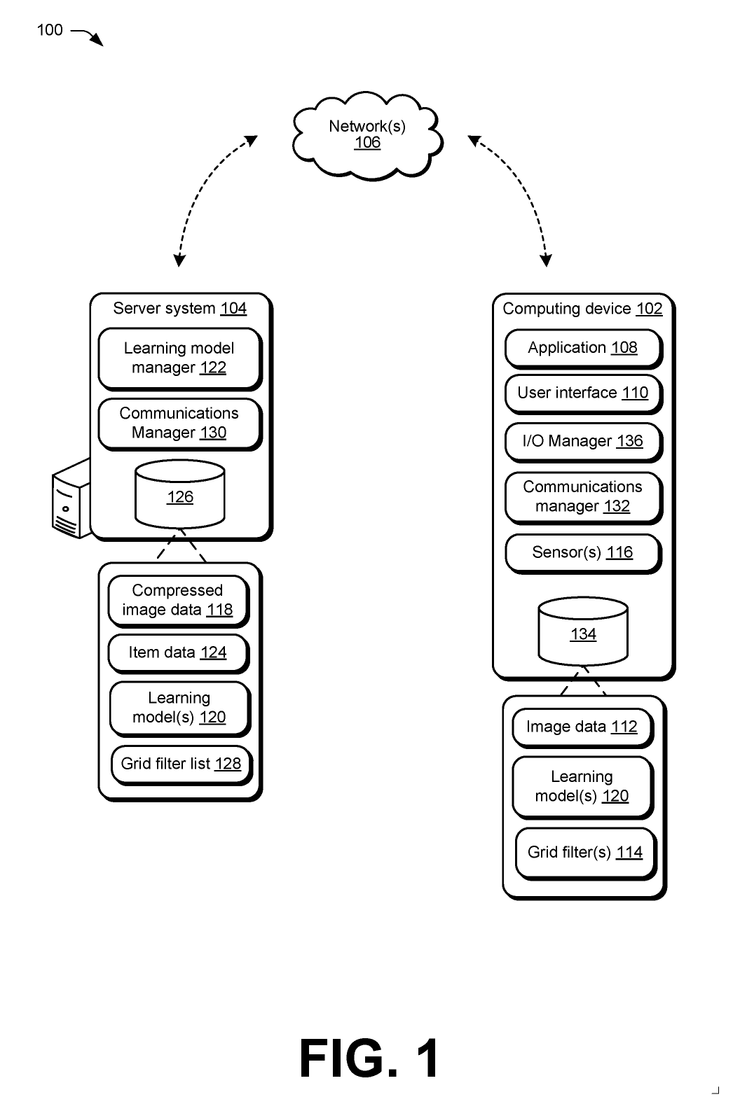

FIG. 1 is an illustration of an environment 100 in an example implementation that is operable to implement techniques described herein. The environment 100 includes a computing device 102 and a server system 104. In one or more implementations, the computing device 102 and the server system 104 may be communicatively coupled via one or more networks 106. An example of the networks 106 is the Internet, although the computing device 102 and the server system 104 may be communicatively coupled using one or more different connections or different networks 106 (e.g., wireless networks) in various implementations. In some examples, the computing device 102 and the server system 104 may exchange instructions, signaling, messages, or other communications via the networks 106 (e.g., a wireless connection, over the air) or via a wired connection (e.g., a physical connections). For example, the server system 104 may transmit signaling to the computing device 102 that includes instructions that cause the computing device 102 to perform one or more actions (display feedback or notifications, select from configured grid filters, etc.). The computing device may receive and decode the signaling and may perform the actions according to the instructions.

Although the server system 104 is depicted in the environment 100 as being separate from the computing device 102, in one or more implementations, an entirety, or various portions of the server system 104 may be implemented at or by the computing device 102. In at least one implementation, for example, at least a portion of the server system 104 may be implemented by an application 108 of the computing device 102 and/or using various resources of the computing device 102, such as hardware resources, an operating system, firmware, and so forth. Alternatively, or additionally, or alternatively, the server system 104 may be implemented by server-based storage resources, processing resources, and so on of devices other than the computing device 102. For example, at least a portion of the server system 104 may be implemented using a third-party service, such as a web services platform that provides one or more hardware and/or other computing resources to support provision of services by web service providers. In variations, an entirety, or various portions of the server system 104 may be implemented at or by a device of the user (e.g., a mobile device, a laptop, a wearable device, or any other device).

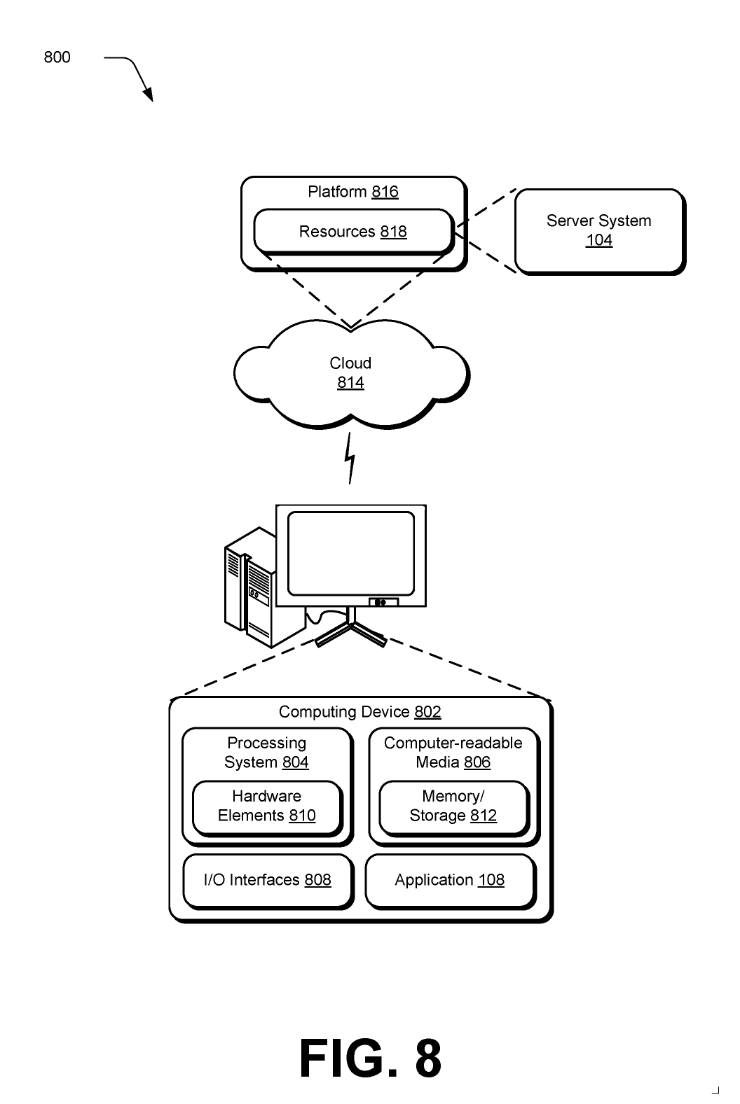

A computing device 102 that implements the environment 100 is configurable in a variety of ways. A computing device 102, for example, may be configurable as a desktop computer, a laptop computer, a mobile device (e.g., assuming a handheld configuration such as a tablet or mobile phone), an IoT device, a wearable device (e.g., a smart watch, a ring, or smart glasses), an augmented reality and/or virtual reality device (e.g., the smart glasses), a server, and so forth. Thus, a computing device 102 may range from full resource devices with substantial memory and processor resources to low-resource devices with limited memory and/or processing resources. Although in instances in the following discussion reference is made to a computing device 102 in the singular, a computing device 102 may also be representative of multiple different devices, such as multiple servers of a server farm utilized to perform operations “over the cloud” as further described in relation to FIG. 8.

In at least one implementation, the application 108 may support communication of data across the networks 106 between the computing device 102 and the server system 104. By supporting such data communication, the application 108 may provide a respective user of the computing device 102 (e.g., and users of other computing devices) access to listing functionality for one or more items. For example, the computing device 102 may receive data from the server system 104. Based on the data, the application 108 may cause various systems of the computing device 102 to output one or more user interfaces 110, such as by displaying the user interfaces 110 via display devices or making accessible voice-based user interfaces. In some cases, the application 108 may be an online marketplace application, such as an e-commerce platform, auction site, or peer-to-peer selling platform, where users can list, buy, and sell various items. The application 108 may also include or interface with social media platforms with marketplace features or specialized marketplaces for categories of items like electronics, fashion, or collectibles. The application 108 may transmit images or grid filter selections from the computing device 102 to the server system 104. Additionally, or alternatively, the application 108 may receive processed listing data or learning model outputs from the server system 104 and/or from the computing device 102 and display them on the computing device 102 (e.g., at the user interface 110).

Through interaction of a user with the computing device 102, the application 108 may receive user input (e.g., image data 112, a selection of a grid filter 114) via the user interfaces 110. Examples of such input may include, but are not limited to, receiving touch input in relation to portions of a displayed user interface, receiving one or more voice commands or other audio input, receiving typed input (e.g., via a physical or virtual (“soft”) keyboard), receiving mouse or stylus input, and so forth. One example of the application 108 is a browser or other web application that facilitates user interaction with listing functionality. Another example of the application 108 is a web-based computer application that facilitates user interaction with listing functionality, such as a mobile application or a desktop application. The application 108 may be configured in different ways, which provide for users to interact with the computing device 102 and by extension perform actions to view, create, or otherwise interact with item listings, without departing from the spirit or scope of the techniques described herein.

The input can include data from one or more sensors 116, such as the image data 112. For example, the sensors 116 may include relatively high-resolution cameras capable of capturing detailed digital images. Image resolution refers to a level of detail and clarity in a digital image, which may be measured by a number of pixels per unit area or a total number of pixels in a digital image. The sensors 116 at the computing device 102 may have various image resolution capabilities, ranging from low-resolution sensors suitable for basic image capture to high-resolution cameras capable of capturing detailed digital images with millions of pixels, providing for detailed representations of items in different lighting conditions and environments. Additionally, or alternatively, the sensors 116 may include depth sensors, such as cameras or light sensors with hardware or software capability to measure a time it takes for light to travel from the camera to an object and back to calculate distance and create depth maps of scenes. Thus, the sensors 116 may capture three-dimensional information or data about objects in a digital image or live camera feed. Additionally, or alternatively, the sensors 116 may include infrared sensors for capturing images in low-light conditions or detecting heat signatures. The sensors 116 may also include motion sensors, such as accelerometers and gyroscopes that can detect device orientation and movement, which may be useful for stabilizing image capture or adjusting the grid filter 114 in real-time. Additionally, or alternatively, the sensors 116 may include ultra-wide-angle lenses or multiple camera arrays that can capture a broader field of view, providing for the simultaneous imaging of more items within the grid filter 114.

In some cases, the sensors 116 may be implemented directly in the hardware of the computing device 102, such as built-in cameras, accelerometers, or gyroscopes that are part of a physical structure of the computing device 102. Additionally, or alternatively, the sensors 116 may be external devices that are connected to the computing device 102 through wired interfaces (e.g., external ports). In some other examples, the sensors 116 may be wirelessly connected to the computing device 102 using protocols, such as Bluetooth, Wi-Fi, or cellular communications. One or more capabilities of the computing device 102 to capture the image data 112 may vary depending on a type or functionality of the sensors 116 implemented by the computing device 102. For example, a computing devices 102 with a relatively high-resolution camera sensor (e.g., greater than a threshold resolution) may capture images with greater detail and clarity, providing for more accurate item identification and analysis and/or more grid segments in a grid filter 114. Depth sensors may enable the computing device 102 to capture three-dimensional information about items, which may improve an accuracy of size and shape estimations. A computing device 102 may implement infrared sensors to capture digital images in relatively low-light conditions (e.g., less than a threshold amount of visible light), expanding the range of environments where items can be photographed. Motion sensors, such as accelerometers and gyroscopes, may stabilize image capture, resulting in higher quality digital images even when the computing device 102 or items are moving. Ultra-wide-angle lenses or multiple camera arrays may provide for the computing device 102 to capture a broader field of view and accommodating more items within a single image or providing alternative perspectives of the same items.

The image data 112 may include digital representations of visual information captured by one or more sensors 116 of the computing device 102. Examples of image data 112 may include, but are not limited to, photographs, scans, video frames, live camera feeds, and augmented reality overlays. For example, the image data 112 may include high-resolution images of multiple items arranged within a grid filter 114, such as a collection of items or products to be listed on an online marketplace. The computing device 102 may capture a single high-resolution photograph of several clothing items arranged in respective grid segments (e.g., in a grid pattern) according to a grid filter 114. Additionally, or alternatively, the computing device 102 may record a video of collectible items being placed into grid segments. The image data 112 may also include real-time or near real-time visual feeds, such as a live camera preview showing items being aligned within a grid filter overlay, or continuously updated depth information from the sensors 116 to determine that items are placed (e.g., aligned) within grid segments of the grid filter 114.

A grid filter 114 may refer to a visual overlay or pattern applied to an image or live camera feed to organize and align multiple items within an image frame. Examples of grid filters 114 may include, but are not limited to, rectangular grids, square grids, hexagonal grids, circular grids, and custom-shaped grids tailored to a defined item type or arrangement. For example, the computing device 102 may apply a 3 by 4 rectangular grid filter to capture images of twelve items or objects arranged in a uniform pattern. Additionally, or alternatively, the computing device 102 may use a hexagonal grid filter for photographing a collection of board game tiles. The grid filter 114 may also include dynamic grids that adjust based on the number or size of items being captured, such as expanding or contracting to fit different quantities of items within a single image. In some cases, the grid filter 114 may incorporate visual guides or alignment markers for display via the user interface 110 to indicate to users to position items within each grid segment. The grid filter 114 may be customizable, providing for manual (e.g., via input by a user) or automatic (e.g., by the computing device 102 or the server system 104) adjustment parameters such as a number of rows and columns, a cell (e.g., segment) size, or grid line thickness to accommodate various item types and quantities. Additionally, or alternatively, the grid filter 114 may include real-time feedback mechanisms, such as highlighting grid cells when items are correctly positioned or providing visual cues for optimal item placement within the grid structure.

In some examples, a computing device 102 that fails to implement (e.g., does not use) a grid filter 114 may cause position and alignment issues for items within an image frame, leading to inefficient image processing tasks, such as item segmentation and identification. Additionally, or alternatively, a computing device that fails to implement grid filters 114 may rely on users to capture individual images for each item, which can be time-consuming and may result in inconsistent lighting, angles, or backgrounds across different items. The inconsistencies in the images may lead to reduced efficiency and lower quality listings when compared to a server system 104 and computing device 102 that incorporate grid filters 114 for organizing and capturing images of multiple items. Failing to utilize grid filters 114 for capturing multiple items in a single high-resolution image may result in inefficient use of advanced imaging capabilities, as the computing device 102 may compress the digital images in the image data 112 for storage. Compressing a digital image may refer to the process of reducing a file size of a digital image without falling below a threshold visual quality. For example, a computing device 102 may reduce a resolution of the digital image, decrease a color depth, or apply various algorithms to remove redundant or less perceptible visual information. Compression techniques may include lossy methods, where some data is permanently discarded, or lossless methods, where the original image can be perfectly reconstructed from the compressed data.

The computing device 102 may compress the image data 112 to obtain compressed image data 118. The computing device 102 may transmit the compressed image data 118 to the server system 104 for storage. Additionally, or alternatively, the computing device 102 may transmit the image data 112 to the server system 104, and the server system 104 may compress the image data 112 for storage. The compressed image data 118 may occupy less space at the computing device 102 or server system 104 than the image data 112, providing for more efficient use of available memory resources. That is, storing compressed image data 118 rather than the image data 112 may enable storage of a larger number of digital images. The server system 104 and/or the computing device 102 may use the compressed image data 118 to generate a listing for one or more items represented in a digital image. For example, the server system 104 and/or the computing device may publish a compressed format of a digital image for listing of an item at the application 108. The smaller file size of the compressed format of the digital image may result in reduced latency for upload and download when publishing the item listing. In some cases, the computing device 102 and/or the server system 104 may implement adaptive compression techniques, where the level of compression may be adjusted based on one or more factors, such as network conditions, device capabilities, or user preferences.

The server system 104 may maintain one or more learning models 120 for implementation or deployment at an application 108 on one or more computing devices, including the computing device 102. A learning model 120 may include a computational algorithm or system trained on relatively large datasets (e.g., greater than a threshold number of data points) to recognize patterns, make predictions, or generate outputs using input data. Learning models 120 may include, but are not limited to, neural networks, decision trees, support vector machines, and classifiers. For example, a convolutional neural network may be used for image recognition tasks, while a recurrent neural network may be suitable for processing sequential data. The application 108 may implement learning models 120 to generate listings of items from an image. For example, an object detection model may identify and locate individual items within a grid-filtered image. A classification model may then categorize each detected item, determining attributes such as item type, color, or brand. Additionally, or alternatively, a natural language processing model may generate descriptive text for item listings using the visual features extracted from the image. In some cases, the application 108 may use transfer learning techniques, where pre-trained models are fine-tuned on specific item datasets to improve accuracy and reduce training time. The application 108 may also implement ensemble methods, combining outputs from multiple models to enhance the overall performance of item identification and listing generation. The learning models 120 may be updated periodically based on user feedback or new data, providing for the application 108 to continuously improve item listing capabilities. In some examples, the application 108 may use federated learning techniques, where model updates are performed on individual devices and aggregated centrally, enhancing privacy and reducing data transfer requirements.

In some cases, the server system 104 may implement a learning model manager 122 to maintain and update the one or more learning models 120. The learning model manager 122 may collect and process item data 124 from various sources, such as user-generated listings, product catalogs, and image databases. The learning model manager 122 may implement training algorithms to analyze the item data 124 and train the learning models 120 to recognize and classify different types of items, item attributes, and market trends. The learning model manager 122 may store the item data 124 and the learning models 120 (e.g., the parameters of the learning models 120, including biases and weights) at data storage 126. Additionally, or alternatively, the learning model manager 122 may store compressed image data 118 and a grid filter list 128 at the data storage 126. The data storage 126 at the server system 104 may include hardware such as hard disk drives, solid-state drives, or tape storage, as well as cloud-based storage solutions. The data storage 126 may utilize database management systems to organize and retrieve data, such as databases or distributed file systems. In some cases, the data storage 126 may employ data redundancy and backup mechanisms to ensure data integrity and availability. For example, the data storage 126 may be distributed to or deployed at multiple geographic locations, such as at geographic location within a threshold distance from the computing device 102. Examples of data that may be stored in the data storage 126 include user account information, item data 124, item listings, transaction records, compressed image data 118, learning models 120, and historical market data. The item data 124 may include information related to products, goods, or services that can be listed, sold, or traded on an online platform or marketplace. For example, the item data 124 may include various attributes, characteristics, and metadata associated with items, such as product names, descriptions, categories, prices, conditions, dimensions, weights, colors, materials, brands, manufacturers, model numbers, inventory levels, seller information, shipping details, and historical sales data. The item data 124 may also include visual information such as images, videos, or models of the items, as well as user-generated content like reviews, ratings, and tags. The item data 124 may be collected from multiple sources, including user submissions, automated web scraping, official product databases, and third-party data providers. The learning model manager 122 may use the item data 124 to train the learning models 120 to populate listing details, perform market analysis, and enhance search and recommendation systems within an e-commerce system.

The learning model manager 122 at the server system 104 may determine which learning models 120 to send to the computing device 102 for use in generating item listings. For example, the server system 104 may determine (e.g., receive an indication of) the capabilities of the computing device 102, the types of items being listed, and the current performance metrics of different models. The learning model manager 122 may select a learning model 120 that satisfies the capabilities of the computing device 102 and is capable of generating listings for the types of items being listed (e.g., trained on similar data). The learning model manager 122 may transmit the selected learning model 120 to the computing device 102 via a communications manager 130. In some examples, the server system 104 may also select one or more grid filters 114 from the grid filter list 128 at the data storage 126 to send to the computing device 102 via the communications manager 130. The grid filter list 128 may refer to a collection or database of predefined grid filter templates or configurations that can be applied for organizing and/or capturing digital images of multiple items. The grid filter list 128 may include various grid patterns, such as rectangular, square, hexagonal, or custom-shaped grids, with different numbers of rows, columns, and cell sizes. The server system may utilize information about the capabilities of the learning models 120 at the computing device 102 to select one or more grid filters 114 for implementation or deployment at the computing device 102 from the grid filter list 128. For example, if the learning models 120 are capable of processing images with a defined number of items or a defined arrangement, then the server system 104 may select a grid filter 114, accordingly. Additionally, or alternatively, the server system 104 may determine a minimum resolution and processing power for implementation of the learning models 120 and may select a grid filter that produces images compatible with the minimum resolution. The server system 104 may also determine one or more sensor capabilities of the computing device 102 to select a grid filter 114 from the grid filter list 128 to send to the computing device 102. For example, if the computing device 102 has a high-resolution camera, then the server system 104 may select a grid filter with more cells (e.g., segments) or finer details. In some other examples, if the computing device 102 has a lower resolution camera, then the server system 104 may select a simpler grid filter with fewer cells (e.g., segments). In some cases, such as if the server system 104 does not have access to the capability information of the computing device 102, then the server system 104 may transmit the entire grid filter list 128 to the computing device, and the computing device 102 may select a grid filter 114 to use for capturing the image data 112.

The communications manager 130 at the server system 104 and the communications manager 132 at the computing device 102 may facilitate the establishment and maintenance of connections between the server system 104 and the computing device 102 for processing images of multiple items and generating item listings. The communications manager 130 at the server system 104 may handle initial connection setup with the computing device 102, receive and interpret image data 112 and grid filter 114 selections, and manage the exchange of learning models 120 and item listings. The communications manager 130 may also perform the encoding and transmission of compressed image data 118 and learning model updates to the computing device 102. At the computing device 102, the communications manager 132 may be responsible for establishing and maintaining the connection with the server system 104, controlling the exchange of image data 112 and grid filter 114 selections, and receiving and implementing learning models 120 for local processing. The communications manager 132 may also manage the transmission of captured images and generated item listings to the server system 104. Both communications managers may implement security protocols to ensure encrypted and authenticated data transfer, manage bandwidth allocation, and handle network-related issues or disconnections. Additionally, or alternatively, the communications managers may coordinate with other components, such as the learning model manager 122 and the application 108, to enable seamless image processing and item listing generation. The communications manager 130 and communications manager 132 may adapt data transfer based on network conditions, device capabilities, and user preferences by implementing adaptive compression or prioritized data transmission.

At the computing device 102, the application 108 may receive and implement one or more learning models 120 sent from the server system 104. For example, the computing device 102 may receive one or more parameters that define the learning models 120 via the communications manager 132. The computing device 102 may store the learning models 120 at data storage 134. The data storage 134 at the computing device 102 may include various types of memory and storage components for storing data, application data (e.g., for the application 108), and system files. The data storage 134 may include volatile memory, such as random-access memory (RAM) for temporary data storage during program execution, as well as non-volatile memory such as solid-state drives (SSDs), hard disk drives (HDDs), or flash memory for long-term data retention. In some cases, the data storage 134 may incorporate removable storage media, such as memory cards. The data storage 134 may store various types of data related to the application 108, including image data 112, grid filters 114, learning models 120, and locally generated item listings. The data storage 134 may also cache frequently accessed data from the server system 104 to improve performance and reduce network usage. The data storage 134 may implement file systems and database management software to organize and retrieve data efficiently.

The computing device 102 may provide image data 112 as input to the learning models 120 to generate item listings. In some cases, the application 108 may use the learning models 120 to process the image data 112 directly on the computing device 102, leveraging local processing capabilities to analyze and extract relevant information from the image data 112. The learning models 120 may be implemented by hardware of the computing device 102, such as by using processors or accelerators for efficient execution. In some examples, the application 108 may segment the image data 112 using the grid filter 114 before passing each segment to the learning models 120 for individual analysis. The learning models 120 may then identify item characteristics, categorize items, and generate descriptive text for each segment that includes a different item. The computing device 102 may also implement ensemble methods, combining the outputs of multiple learning models 120 to improve accuracy and robustness in item listing generation. Additionally, or alternatively, the application 108 may adapt the implementation of the learning models 120 based on the current processing load and battery status of the computing device 102. The computing device 102 may offload some computations to the server system 104 when available resources (e.g., processing and power resources) of the computing device 102 fall below a threshold value.

In some examples, the computing device 102 may transmit image data 112 to the server system 104 for processing. The server system 104 may use the learning models 120 to analyze the received image data 112 and generate item listings. The learning models 120 (e.g., implemented by the computing device 102 and/or the server system 104) may be trained to detect and classify items within grid-filtered images, extract relevant attributes, and generate appropriate listing descriptions. For example, the application 108 and/or the learning model manager 122 may provide the image data 112 as input to the learning models 120, and the learning models 120 may output item classifications, attribute descriptions, and suggested listing details. In some cases, the learning model manager 122 may continuously update and refine the learning models 120 based on user interactions, feedback on generated listings, and new item data. The continuous update or refinement may provide for improved accuracy in item identification, attribute extraction, and listing generation across different item categories and market conditions.

In some cases, the computing device 102 may display the grid filter 114 via the user interface 110 to facilitate the capture and processing of images including multiple items. In some cases, the computing device 102 may overlay the grid filter 114 on a live camera feed displayed via the user interface 110. This real-time application of the grid filter 114 may provide for the computing device to verify that the items are aligned with the grid segments of the grid filter 114 prior to capturing an image. The computing device 102 may analyze the video stream or live image feed to detect the presence and positioning of items within the grid filter 114 segments. The device may employ computer vision techniques, such as edge detection, object recognition, or color analysis, to identify item boundaries and determine if the item boundaries align with the grid segments, such that one grid segment includes one item.

As items are positioned within the grid filter 114, the computing device 102 may provide real-time visual feedback through the user interface 110. For example, the device may display color-coded overlays on grid segments, with green indicating proper item alignment and red signaling misalignment. The computing device 102 may also use augmented reality techniques to project virtual guidelines or item outlines onto the live camera feed. The computing device 102 may display various types of notifications via the user interface 110 based on the real-time analysis of item alignment within the grid filter 114. The notifications may include alignment prompts, such as messages including text “Please adjust item in top-left segment” or “Rotate item in center segment slightly clockwise.” Additionally, or alternatively, the notifications may include completion indicators, such as a message including text “All items aligned successfully” or “Ready to capture image.” Additionally, or alternatively, the notifications may include error alerts, such as text including “Item detected outside grid boundaries” or “Too many items in single segment.” Additionally, or alternatively, the notifications may include suggestions, such as text including “Try using a 3x4 grid for better fit” or “Increase lighting for clearer detection.”

In response to these notifications, the computing device 102 may receive various types of input through the I/O manager 136. These inputs may include, but are not limited to, touch gestures (e.g., taps to select grid segments, swipes to adjust grid size or orientation), voice commands (e.g., instructions, including “Capture image” or “Switch to 4x4 grid”), a physical button press, or motion inputs, among other examples. The I/O manager 136 may refer to hardware or software of the computing device 102 that handles input and output operations, facilitating communication between the user, the hardware of the computing device 102 (the sensors 116, display hardware, the antennas, etc.), and the application 108. The I/O manager 136 may perform functions, such as processing input via a selectable element (e.g., a software or hardware button, text box, or other selectable element) that indicate for the computing device 102 to update the grid filter 114 to a different size, capturing an image according to input from a selectable element, and controlling a display to show grid filter 114 overlays in real-time and alignment feedback, among other examples.

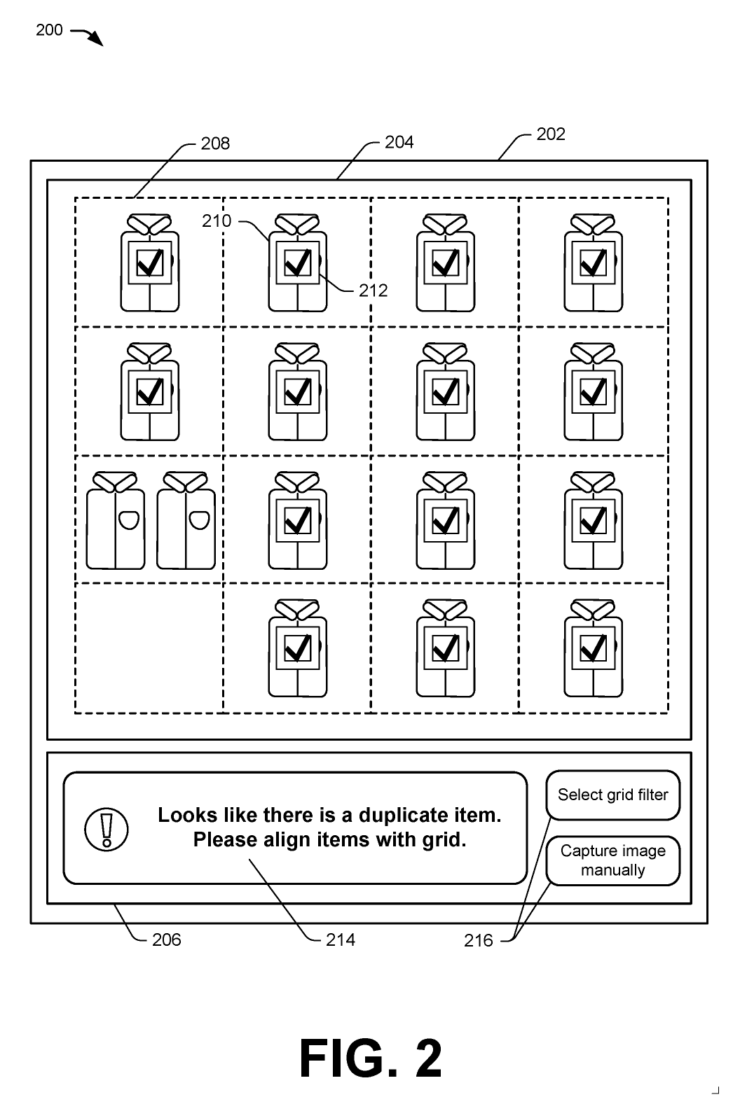

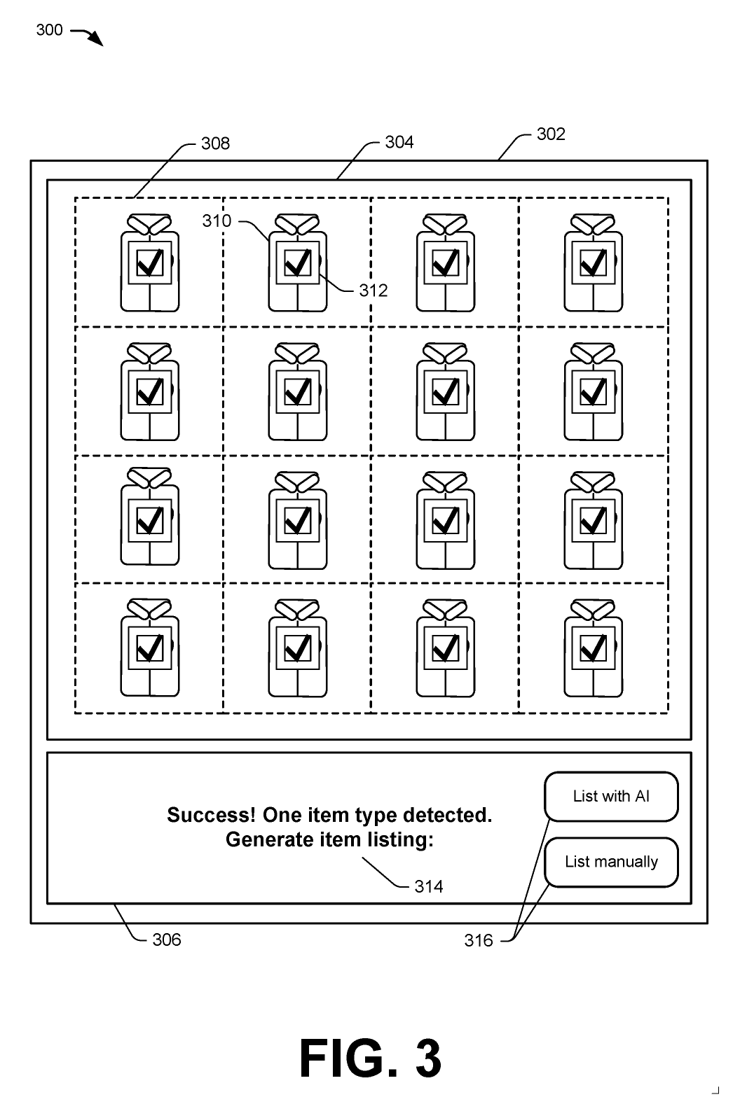

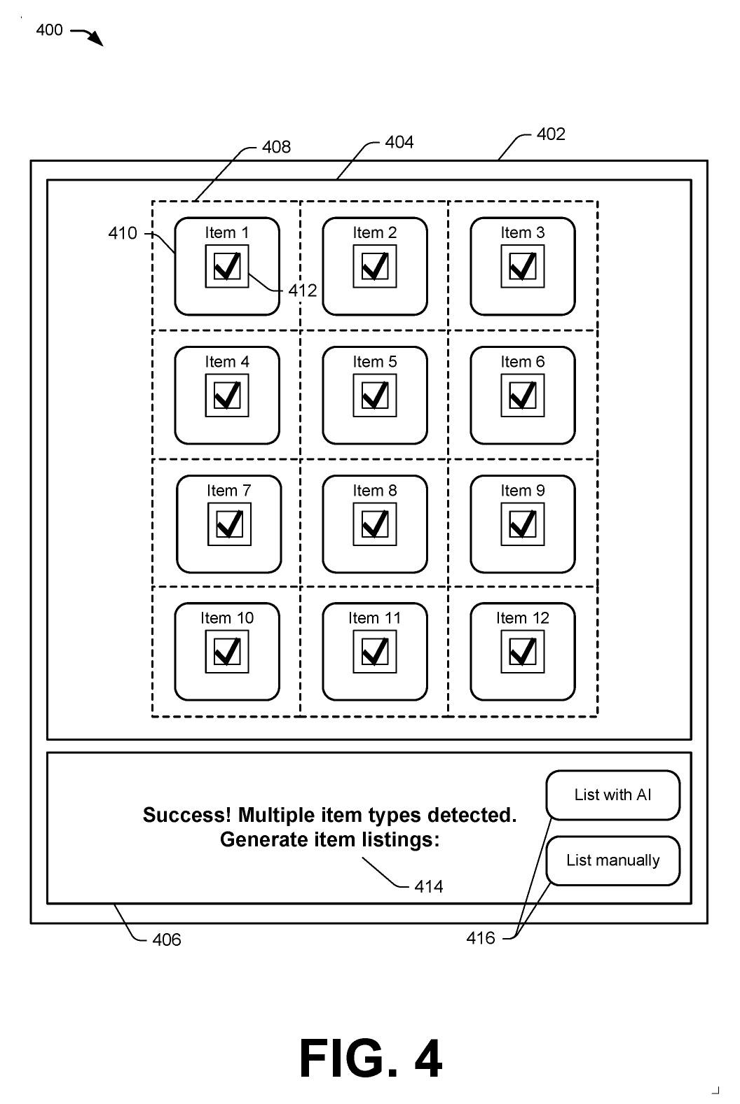

If the items in an image align with segments of a grid filter 114, then the computing device 102 may automatically (e.g., without further input from a user via the user interface 110) capture a digital image of multiple items, which is described in further detail with respect to FIGS. 3 and 4. In some other examples, if the items in the image fail to align (e.g., do not align) with the grid filter 114, then the computing device 102 may display an error notification via the user interface 110 and may not capture a digital image of multiple items, which is described in further detail with respect to FIG. 2. The computing device 102 may receive input that indicates for the computing device 102 to capture the digital image independent of the alignment of items within the grid filter 114. Once the items are aligned with the grid filter 114, then the computing device 102 may capture the image data 112. The computing device 102 may process the image data 112 to generate one or more listings of the items in the image data 112. Additionally, or alternatively, the computing device 102 may transmit the image data 112 to the server system 104 for the server system 104 to generate the one or more listings of the items in the image data 112. For example, the computing device 102 may not be capable of supporting, implementing, or deploying the learning models 120 that generate the listings from the image data 112, and may transmit the image data 112 to the server system 104, which is capable of supporting, implementing, or deploying the learning models 120. In some cases, if the image includes variations of a same item, then the computing device 102 and/or the server system 104 may generate a single listing for the item. The single listing may include an indication of the variations of the item, as well as an inventory or numerical quantity of the items available. The variations of the item may include different sizes, different colors, or any other variations for an item. In some other cases, if the image includes different items (e.g., items in a same category, such as trading cards), then the computing device 102 and/or the server system 104 may generate multiple listings, such that each item has a listing.

The computing device 102 may segment the image data 112 using the grid filter 114, such that each item has a corresponding image segment. The computing device 102 may store the image segments at the data storage 134 and/or may transmit the image segments to the server system 104 for storage at the data storage 126. In some cases, each image segment may be compressed to a resolution for publishing to the application 108. Compressing each image segment (e.g., rather than the entire image) may provide for efficient storage and retrieval of individual item images when generating or updating listings. Additionally, or alternatively, compressing each image segment may provide flexibility in adjusting compression levels according to the characteristics of each item, which may preserve more detail for complex items while reducing file size for simpler items. In some other examples, the entire image may be compressed to a resolution for publishing to the application 108, where individual image segments may be linked to each listing. When the listings are published, the individual segments may be extracted and published for individual listings rather than using the larger image. Compressing an entire image of multiple items (e.g., rather than compressing each image segment) may improve storage capacity, as a single compressed image is stored, and may facilitate management of related items, as the original spatial relationships between items are preserved in the full image. The computing device 102 and/or the server system 104 may determine to compress each image segment or the entire image according to an available storage capacity, a number of items in each image, and a frequency of accessing individual item images.

The environment 100 leverages the capabilities of the computing device 102 and the server system 104 to efficiently capture and list multiple items using a single image and a grid filter 114. The application 108 on the computing device 102 utilizes the grid filter 114 to streamline the image capture process, providing for alignment of multiple items within a single frame. Implementing a grid filter 114 reduces time and computing resources (e.g., processing, power, memory) for capturing digital images and listing items. For example, one or more sensors 116 of the computing device 102 and the grid filter 114 ensure high-quality image capture, while the I/O manager 136 facilitates real-time user feedback and interaction. The learning models 120 implemented on the computing device 102 enable local processing of image data 112, reducing latency and enhancing data security by minimizing raw image transmission over the networks 106. The server system 104 provides additional processing power and storage capabilities through a learning model manager 122 and data storage 126. The distributed processing balances (e.g., distributes, optimizes) resource usage across devices and provides for scalable item listing generation. The communications manager 130 and the communications manager 132 ensure efficient and secure data transfer between the computing device 102 and the server system 104, facilitating the item listing generation and publishing via the application 108. It is to be appreciated that the server system 104 and/or the computing device 102 may include more, fewer, or different components without departing from the spirit or scope described herein.

Having considered an example of an environment, consider now a discussion of some example details of the techniques for grid filter for images of multiple items in accordance with one or more implementations.

### Generation of Item Listings Using a Grid Filter

FIG. 2 depicts an example of a user interface 200 for generating a single listing for items in an image based on a grid filter. The user interface 200 may implement, or be implemented by, aspects of FIG. 1. For example, the user interface 200 may be implemented by a computing device, such as the user interface 110 implemented by a computing device 102 as described with reference to FIG. 1.

The user interface 200 includes a display 202 that outputs an image 204. The image 204 may be a single frame or may be a live image feed or live camera feed (e.g., a consecutive series of multiple frames) including multiple items. The user interface 200 may also include a notification 206. The display 202 may include a grid filter 208 that is overlaid on the image 204, such that the image is divided (e.g., segmented, portioned) into image segments according to a numerical quantity of grid segments in the grid filter 208. For example, the grid filter 208 includes 16 image segments based on the grid filter 208 being 4 by 4. The grid filter 208 may be an example of the grid filter 114, as described with reference to FIG. 1.

In some examples, a computing device may select the grid filter 208 and/or may receive an indication of the grid filter 208 from a server system, as described with reference to FIG. 1. The numerical quantity (e.g., number, amount) of grid segments in the grid filter 208 may be based on a capability of a processor of the computing device, one or more sensors of the computing device, one or more capabilities of the machine learning model (e.g., a minimum resolution for to satisfy a performance criterion of the machine learning model), and/or a threshold resolution for publishing an item listing. For example, the computing device may select a grid filter 208 to maximize the numerical quantity of grid segments according to the capabilities and threshold resolution.

The computing device may determine whether the image 204 includes item representations 210 in each grid segment or image segment. An item representation 210 may refer to an item in the image 204 within the grid filter 208. The item may be part of a same category as the other items in the image 204. In some cases, there may be multiple of a same item in the image 204 or there may be different items in the image 204. For example, the items in the image 204 may include a same shirt with different colors, sizes, or other characteristics. In some other examples, the items in the image 204 may be different, such as different trading cards with different values, which is described in further detail with respect to FIG. 4.

If an item representation 210 is aligned in a grid segment, then the computing device may output an alignment indicator 212 at the display 202. For example, the computing device may output checkmarks or any other visual indicator that an item representation 210 is properly aligned within a respective grid segment. The alignment indicators 212 provide visual feedback to the user about the positioning of items within the grid filter 208. If each of the item representations 210 (e.g., all of the item representations 210 in the image 204) are aligned within the grid segments of the grid filter 208, then the computing device may capture the image 204. If an item representation 210 in the image 204 is not aligned within a grid segment of the grid filter 208, then the computing device may refrain from capturing (e.g., may not capture) the image 204.

Additionally, or alternatively, the user interface 200 outputs a notification 206 that includes a message 214. For example, the message 214 may indicate whether a grid segment in the image 204 includes an item representation 210 that is misaligned (e.g., not aligned) with the grid segment. The message 214 may include a text value, such as “Looks like there is a duplicate item. Please align items with grid.”

A computing device may generate the message 214 dynamically based on a live (e.g., real-time) analysis of the image 204 and grid filter 208 alignment. In some cases, the computing device may implement a learning model trained on various item arrangements and grid configurations to detect and classify alignment issues. The learning model may analyze features, such as item shape, size, color, and position within each grid segment to identify misalignment between item representations 210 and grid segments. The notification text may be selected from a predefined set of messages or generated using natural language processing techniques, tailoring the content to an identified misalignment. Additionally, or alternatively, the notification may be updated in real-time (e.g., without a delay, live) as the user adjusts item positions, providing immediate feedback on alignment improvements or new issues that arise during the capture process.

The user interface 200 includes selectable elements 216, such as one or more buttons, to provide options for “Select grid filter” and “Capture image manually.” The computing device may receive input via the selectable elements 216. For example, the “Select grid filter” option may provide for users to select different grid configurations, while the “Capture image manually” option may bypass a grid alignment criterion (e.g., each of the item representations 210 aligning with the grid segments).

FIG. 3 depicts an example of a user interface 300 for generating multiple listings for items in an image based on a grid filter. The user interface 300 may implement, or be implemented by, aspects of FIGS. 1 and 2. For example, the user interface 300 may be implemented by a computing device, such as the user interface 110 implemented by a computing device 102 as described with reference to FIG. 1.

The user interface 300 includes a display 302 that outputs an image 304. The image 304 may be a single frame or may be a live image feed or live camera feed including multiple items. The user interface 300 may also include a notification 306. The display 302 may include a grid filter 308 that is overlaid on the image 304, such that the image is divided into image segments according to a numerical quantity of grid segments in the grid filter 308 (e.g., as described with reference to FIGS. 1 and 2).

The computing device may determine whether the image 304 includes item representations 310 in each grid segment or image segment. The item may be part of a same category as the other items in the image 304. In some cases, there may be multiple of a same item in the image 304 or there may be different items in the image 304. For example, the items in the image 304 may include a same shirt with different colors, sizes, or other characteristics.

If an item representation 310 is aligned in a grid segment, then the computing device may output an alignment indicator 312 at the display 302, as described with reference to FIG. 2. If each of the item representations 310 (e.g., all of the item representations 310 in the image 304) are aligned within the grid segments of the grid filter 308, then the computing device may capture the image 304. If an item representation 310 in the image 304 is not aligned within a grid segment of the grid filter 308, then the computing device may refrain from capturing (e.g., may not capture) the image 304.

Additionally, or alternatively, the user interface 300 outputs a notification 306 that includes a message 314. For example, the message 314 may include a completion indicator that indicates that the grid segments in the image 304 are aligned with item representations 310. The message 314 may include a text value, such as “Success! One item type detected. Generate item listing.” A computing device may generate the message 314 dynamically based on a live (e.g., real-time) analysis of the image 304 and grid filter 308 alignment, as described with reference to FIG. 2. For example, the computing device may automatically (e.g., without further input) capture the image 304 and display the message 314. The message 314 provides feedback to a user that indicates a successful detection of a single item type within the image 304 and prompts the user to proceed with generating an item listing.

The user interface 300 includes selectable elements 316, such as one or more buttons, to provide options for “List with AI” and “List manually.” The selectable elements 316 provide for the user to select between automated and manual methods for generating an item listing based on the captured image 304 and detected items. In some cases, the computing device may generate an item listing manually based on user input. For example, the user may select the “List manually” option and input item details, such as title, description, price, and condition through text fields or dropdown menus. The user may also manually crop and adjust individual item images from the grid-filtered image. When generating an item listing automatically, the computing device may implement learning models (e.g., machine learning models, artificial intelligence models) to analyze the grid-filtered image. The learning models may extract item characteristics, such as color, size, brand, and condition from the image data. The computing device may then populate listing fields with the extracted information, which may include referencing a database of similar items to suggest a value of the item (e.g., pricing). In some examples, the automatic listing process may generate item descriptions using natural language processing techniques. The computing device may also apply image processing algorithms to automatically crop and enhance individual item images from the grid-filtered capture. Both manual and automatic listing generation methods may allow for user review and editing before final publication.

In some examples, the computing device may determine that a single type of item is detected and may generate a single listing for the item. The listing may include a value that indicates a numerical quantity of items available, as well as any variations in the item (color, brands, size, etc.). The computing device may publish the listing to an application (e.g., the application 108 as described with reference to FIG. 1, an online marketplace application).

FIG. 4 depicts an example of a user interface 400 for generating multiple listings for items in an image based on a grid filter. The user interface 400 may implement, or be implemented by, aspects of FIGS. 1, 2, and 3. For example, the user interface 400 may be implemented by a computing device, such as the user interface 110 implemented by a computing device 102 as described with reference to FIG. 1.

The user interface 400 includes a display 402 that outputs an image 404. The image 404 may be a single frame or may be a live image feed or live camera feed including multiple items. The user interface 400 may also include a notification 406. The display 402 may include a grid filter 408 that is overlaid on the image 404, such that the image is divided into image segments according to a numerical quantity of grid segments in the grid filter 408 (e.g., as described with reference to FIGS. 1 and 2). For example, the grid filter 408 may divide the image 404 into 12 segments using a 4 by 3 grid filter 408.

The computing device may determine whether the image 404 includes item representations 410 in each grid segment or image segment. The item may be part of a same category as the other items in the image 404 (e.g., a trading car category). In some cases, there may be multiple of a same item in the image 404 or there may be different items in the image 404. For example, the items in the image 404 may include different trading cards with different characteristics and value.

If an item representation 410 is aligned in a grid segment, then the computing device may output an alignment indicator 412 at the display 402, as described with reference to FIG. 2. If each of the item representations 410 (e.g., all of the item representations 410 in the image 404) are aligned within the grid segments of the grid filter 408, then the computing device may capture the image 404. If an item representation 410 in the image 404 is not aligned within a grid segment of the grid filter 408, then the computing device may refrain from capturing (e.g., may not capture) the image 404.

Additionally, or alternatively, the user interface 400 outputs a notification 406 that includes a message 414. For example, the message 414 may include a completion indicator that indicates that the grid segments in the image 404 are aligned with item representations 410. The message 414 may include a text value, such as “Success! Multiple item types detected. Generate item listing.” A computing device may generate the message 414 dynamically based on a live (e.g., real-time) analysis of the image 404 and grid filter 408 alignment, as described with reference to FIG. 2. For example, the computing device may automatically (e.g., without further input) capture the image 404 and display the message 414. The message 414 provides feedback to a user that indicates a successful detection of a single item type within the image 404 and prompts the user to proceed with generating an item listing.

The user interface 400 includes selectable elements 416, such as one or more buttons, to provide options for “List with AI” and “List manually.” The selectable elements 416 provide for the user to select between automated and manual methods for generating multiple item listings based on the captured image 404 and detected items. In some cases, the computing device may generate the item listings manually based on user input. For example, the user may select the “List manually” option and input item details, such as title, description, price, and condition through text fields or dropdown menus. The user may also manually crop and adjust individual item images from the grid-filtered image. In contrast, when generating an item listing automatically, the computing device may implement learning models (e.g., machine learning models, artificial intelligence models) to analyze the grid-filtered image. The learning models may extract item characteristics, such as color, size, brand, and condition from the image data. For example, the learning models may extract unique item characteristics for each item in the image data, where the image data includes multiple different items. The computing device may then populate listing fields with the extracted information, which may include referencing a database of similar items to suggest a unique value for each item in the image data (e.g., pricing). In some examples, the automatic listing process may generate item descriptions using natural language processing techniques. The computing device may also apply image processing algorithms to automatically crop and enhance individual item images from the grid-filtered capture. Both manual and automatic listing generation methods may allow for user review and editing before final publication.

In some examples, the computing device may determine that multiple types of items are detected and may generate listings for each item. The listings may include one or more unique characteristics of each item (a pricing structure, a grade or rarity of the item, a quality of the item, etc.). Thus, the listings are tailored to attributes of the respective items, providing clarity and precision for one or more users. The computing device may publish the listings to an application (e.g., the application 108 as described with reference to FIG. 1, an online marketplace application).

In some cases, the computing device may apply one or more image filters to the respective image segments based on processing capabilities of the device. The image filters may correct (e.g., enhance, update, modify, edit) the image segments. For example, the image filters may correct the image segments by removing backgrounds, improving lighting, adjusting contrast, sharpening details, or correcting color balance in digital images. The computing device may then store the processed image segments for use in publishing the item listings and/or may transmit the processed image segments to the server system for storage. For example, the computing device may compress and transmit the image segments to an application server of the server system for storage and later retrieval when publishing listings.

### Example Procedures

This section describes examples of procedures for grid filter for images of multiple items. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

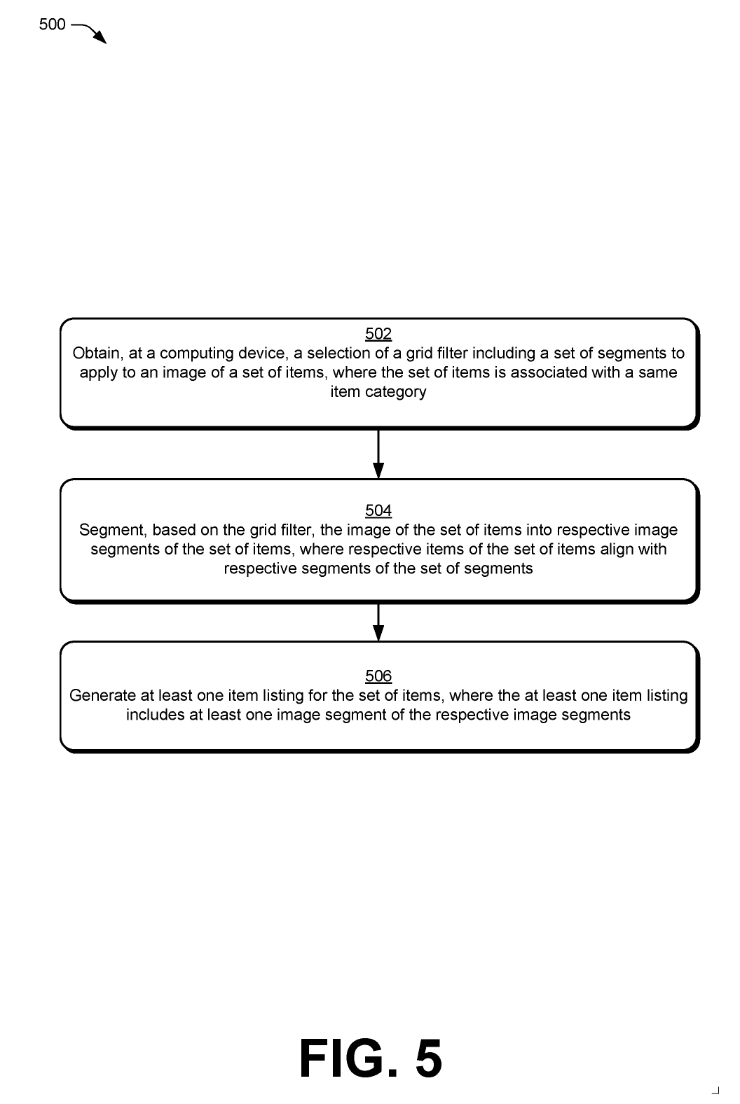

FIG. 5 depicts a procedure 500 in an example implementation of a grid filter for images of multiple items.

At 502, a selection of a grid filter including a set of segments is obtained at a computing device to apply to an image of a set of items, where the set of items is associated with a same item category. In some examples, obtaining the selection of the grid filter includes receiving input via a user interface of the computing device that indicates the selection of the grid filter. In some other examples, obtaining the selection of the grid filter includes receiving a set of grid filters from an application server (e.g., a server system 104, as described with reference to FIG. 1) and selecting the grid filter from the set of grid filters based on an image resolution capability associated with the computing device and a threshold image resolution for the at least one item listing.

In some examples, prior to obtaining the selection of the grid filter, the computing device receives a live image feed of the set of items. The computing device displays the grid filter via a user interface of the computing device over the live image feed of the set of items. The computing device then captures the image of the set of items based on the set of items aligning with the respective segments of the set of segments in the grid filter, as described with reference to FIGS. 3 and 4. The respective segments of the set of segments correspond to the respective image segments of the set of items. The computing device may also display feedback via the user interface that indicates at least one item of the set of items fails to align with the respective segments of the set of segments, as described with reference to FIG. 2.

At 504, the image of the set of items is segmented into respective image segments of the set of items based on the grid filter, where respective items of the set of items align with respective segments of the set of segments. In some examples, the computing device may receive the image of the set of items. The computing device may display the grid filter over the image of the set of items via a user interface of the computing device. The segmenting of the image of the set of items is responsive to the set of items aligning with the respective segments of the set of segments, and the respective segments of the set of segments correspond to the respective image segments of the set of items.

At 506, at least one item listing is generated for the set of items, where the at least one item listing includes at least one image segment of the respective image segments. In some examples, generating the at least one item listing includes receiving one or more respective characteristics of the set of items and a measure of similarity between the one or more respective characteristics as output from a learning model and based on providing the image of the set of items as input to the learning model. Based on the measure of similarity between the one or more respective characteristics satisfying one or more threshold values, either a single item listing for the set of items or respective item listings for the set of items is generated. For example, if the items are similar (e.g., the measure of similarity is greater than a threshold value), then the computing device may generate a single listing for the items. In some other examples, if the items are not similar (e.g., the measure of similarity is less than a threshold value), then the computing device may generate multiple listings for the items. One or more fields of the at least one item listing include the one or more respective characteristics of the set of items.

In some cases, prior to generating the at least one item listing for the set of items, one or more image filters are applied to the respective image segments based on a processing capability of the computing device. The one or more image filters correct the respective image segments.

Following the generation of the at least one item listing, the computing device may transmit at least one of the respective image segments, the image of the set of items, or an indication of the grid filter to an application server for storage based on a resolution of the image of the set of items. The computing device may also publish, responsive to generating the at least one item listing, the at least one item listing via an application server. In some examples, a numerical quantity of segments of the set of segments is based on an image resolution capability associated with the computing device and a threshold image resolution associated with the respective image segments.

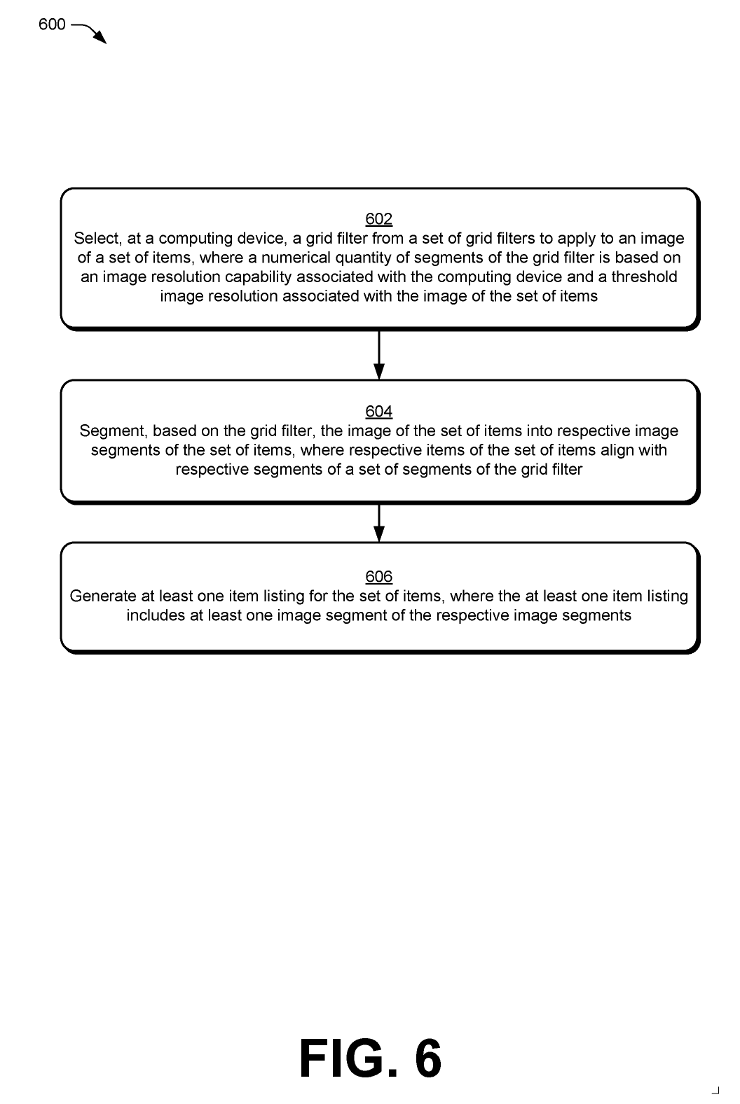

FIG. 6 depicts a procedure 600 in an example implementation of a grid filter for images of multiple items.

At 602, a grid filter is selected from a set of grid filters at a computing device to apply to an image of a set of items. The numerical quantity of segments of the grid filter is based on an image resolution capability associated with the computing device and a threshold image resolution associated with the image of the set of items. In some examples, the threshold image resolution is determined based on one or more of an image resolution capability of a learning model to generate the at least one item listing or a minimum resolution associated with the at least one item listing.

At 604, the image of the set of items is segmented into respective image segments of the set of items based on the grid filter. The respective items of the set of items align with respective segments of a set of segments of the grid filter. In some examples, prior to segmenting the image, the computing device receives a live image feed of the set of items. The computing device displays the grid filter via a user interface of the computing device over the live image feed of the set of items. The computing device then captures the image of the set of items based on the set of items aligning with the respective segments of the set of segments, as described with reference to FIGS. 3 and 4. The respective segments of the set of segments correspond to the respective image segments of the set of items. The computing device may also display feedback via the user interface that indicates at least one item of the set of items fails to align with the respective segments of the set of segments, as described with reference to FIG. 2.

At 606, at least one item listing is generated for the set of items, where the at least one item listing includes at least one image segment of the respective image segments. In some examples, generating the at least one item listing includes receiving one or more respective characteristics of the set of items and a measure of similarity between the one or more respective characteristics as output from a learning model and based on providing the image of the set of items as input to the learning model. Based on the measure of similarity between the one or more respective characteristics satisfying one or more threshold values, either a single item listing for the set of items or respective item listings for the set of items is generated. In some cases, one or more fields of the at least one item listing include the one or more respective characteristics of the set of items.

In some cases, the computing device transmits at least one of the respective image segments, the image of the set of items, or an indication of the grid filter to an application server for storage based on a resolution of the image of the set of items. In some examples, the at least one item listing is published via an application server, responsive to generating the at least one item listing.

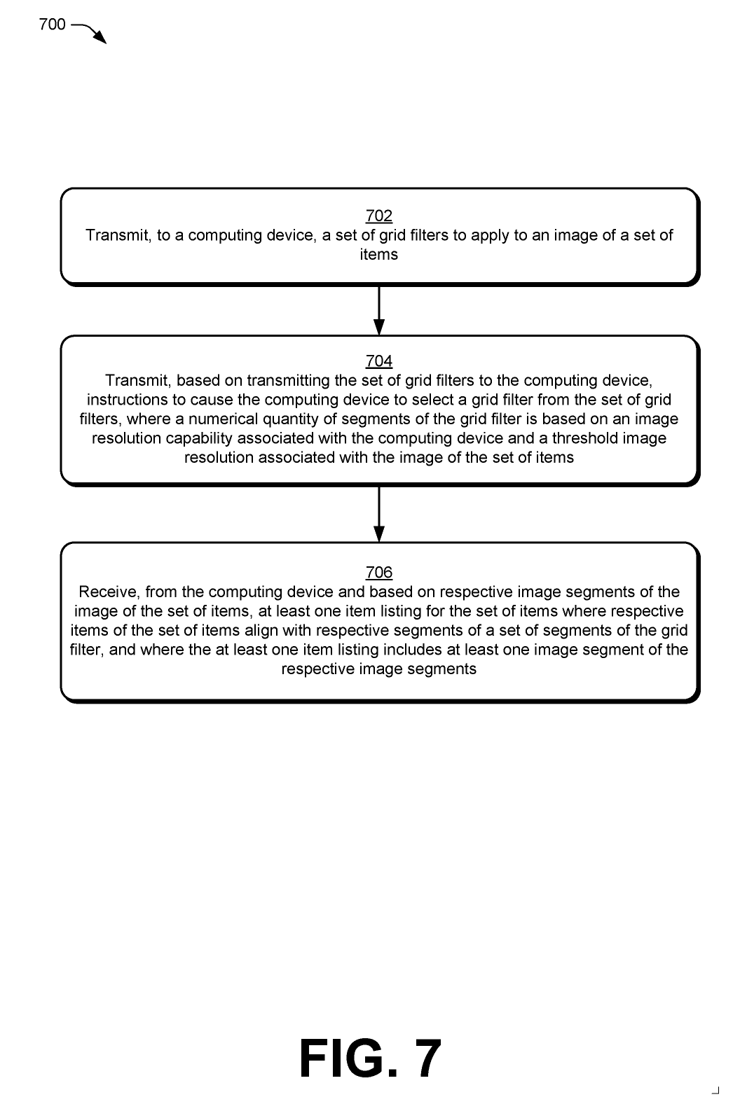

FIG. 7 depicts a procedure 700 in an example implementation of a grid filter for images of multiple items.

At 702, a set of grid filters is transmitted to a computing device to apply to an image of a set of items. For example, a server system (e.g., a device at the server system) transmits a set (e.g., list, multiple) grid filters to a computing device, as described with reference to FIG. 1. The computing device may apply a grid filter to an image of multiple items. In some cases, the server system selects the set of grid filters according to the threshold image resolution, such that the grid filters in the set satisfy the threshold image resolution. The server system may determine (e.g., obtain, identify, receive an indication of) the threshold image resolution according to one or more of an image resolution capability of a learning model to generate the at least one item listing or a minimum resolution for an image published with the at least one item listing.

In some examples, the server system transmits the image of the set of items to the computing device. In some cases, the server system may determine whether the set of items aligns with the respective segments of a set of segments of a grid filter prior to transmitting the image of the set of items to the computing device. The respective segments of the set of segments correspond to the respective image segments of the set of items.

At 704, instructions are transmitted to the computing device based at least in part on transmitting the plurality of grid filters to the computing device to cause the computing device to select a grid filter from the set of grid filters. A numerical quantity of segments of the grid filter is based on an image resolution capability associated with the computing device and a threshold image resolution associated with the image of the set of items. In some cases, the server system may transmit signaling (e.g., over the air via a wireless connection or via a wired connection) to the computing device. The signaling may include data packets with the instructions. Upon reception of the instructions, the computing device may select a grid filter from the set of grid filters (e.g., based on the image resolution capability of the computing device and/or the threshold image resolution of the image). The instructions cause the computing device to select the grid filter by indicating for the computing device to select the grid filter.

In some examples, the server system may transmit additional instructions to cause the computing device to display the grid filter over a live image feed of the set of items via a user interface of the computing device. The computing device captures the image of the set of items if the set of items aligns with the respective segments of the set of segments. The respective segments of the set of segments correspond to the respective image segments of the set of items. In some cases, the server system may transmit additional instructions to cause the computing device to display feedback via a user interface of the computing device that indicates at least one item of the set of items fails to align with the respective segments of the set of segments.

At 706, at least one item listing for the set of items is received from the computing device based on respective image segments of the image of the set of items. Respective items of the set of items align with respective segments of a set of segments of the grid filter. The at least one item listing includes at least one image segment of the respective image segments. For example, the computing device may generate the item listing (e.g., as described with reference to FIGS. 2 through 6), and may send the generated item listing to a server system.

In some cases, receiving the at least one item listing is based on a measure of similarity between one or more respective characteristics of the set of items satisfying one or more threshold values. For example, the computing device may determine whether the respective characteristics of the set of items is within a threshold value and may transmit a single item listing for the set of items or respective item listings for the set of items, accordingly. One or more fields of the at least one item listing include the one or more respective characteristics of the set of items

In some examples, the server system receives at least one of the respective image segments, the image of the set of items, or an indication of the grid filter from the computing device and based on a resolution of the image of the set of items. The server system stores the at least one of the respective image segments, the image of the set of items, or the indication of the grid filter at a database (e.g., a distributed database system or at a local database of the server system). For example, the server system may store the at least one of the respective image segments, the image of the set of items, or the indication of the grid filter at multiple databases at respective geographic locations, such that computing devices in the respective geographic locations may access a database with reduced latency. In some other examples, the server system may store the at least one of the respective image segments, the image of the set of items, or the indication of the grid filter at a single, central database to reduce the use of memory resources related to storing the at least one of the respective image segments, the image of the set of items, or the indication of the grid filter at multiple different geographic locations. In some cases, the server system may publish the at least one item listing.

Having described examples of procedures in accordance with one or more implementations, consider now an example of a system and device that can be utilized to implement the various techniques described herein.

### Example System and Device

FIG. 8 illustrates an example of a system generally at 800 that includes an example of a computing device 802 that is representative of one or more computing systems and/or devices that may implement the various techniques described herein. This is illustrated through inclusion of the application 108 and the server system 104. The computing device 802 may be, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interfaces 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware elements 810 that may be configured as processors, functional blocks, and so forth. This may include implementation in hardware as an application specific integrated circuit or other logic device formed using one or more semiconductors. The hardware elements 810 are not limited by the materials from which they are formed, or the processing mechanisms employed therein. For example, processors may be comprised of semiconductor(s) and/or transistors (e.g., electronic integrated circuits (ICs)). In such a context, processor-executable instructions may be electronically executable instructions.

The computer-readable media 806 is illustrated as including memory/storage 812. The memory/storage 812 represents memory/storage capacity associated with one or more computer-readable media. The memory/storage 812 may include volatile media (such as random-access memory (RAM)) and/or nonvolatile media (such as read only memory (ROM), Flash memory, optical disks, magnetic disks, and so forth). The memory/storage 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive, or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable, and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

The techniques described herein may be supported by various configurations of the computing device 802 and are not limited to the specific examples of the techniques described herein. This functionality may also be implemented all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 may include applications and/or data that can be utilized while computer processing is executed on servers that are remote from the computing device 802. Resources 818 can also include services provided over the Internet and/or through a subscriber network, such as a cellular or Wi-Fi network.

The platform 816 may abstract resources and functions to connect the computing device 802 with other computing devices. The platform 816 may also serve to abstract scaling of resources to provide a corresponding level of scale to encountered demand for the resources 818 that are implemented via the platform 816. Accordingly, in an interconnected device embodiment, implementation of functionality described herein may be distributed throughout the system 800. For example, the functionality may be implemented in part on the computing device 802 as well as via the platform 816 that abstracts the functionality of the cloud 814.

### Conclusion

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A computer-implemented method comprising:
obtaining, at a computing device, a selection of a grid filter comprising a plurality of segments to apply to an image of a plurality of items, wherein the plurality of items is associated with a same item category;
segmenting, based at least in part on the grid filter, the image of the plurality of items into respective image segments of the plurality of items, wherein respective items of the plurality of items align with respective segments of the plurality of segments; and
generating at least one item listing for the plurality of items, wherein the at least one item listing comprises at least one image segment of the respective image segments.

2. The computer-implemented method of claim 1, wherein obtaining the selection of the grid filter comprises receiving, via a user interface of the computing device, input that indicates the selection of the grid filter.

3. The computer-implemented method of claim 1, wherein obtaining the selection of the grid filter comprises:
receiving, from an application server, a plurality of grid filters; and
selecting, based at least in part on an image resolution capability associated with the computing device and a threshold image resolution associated with the at least one item listing, the grid filter from the plurality of grid filters.

4. The computer-implemented method of claim 1, further comprising:
receiving, at the computing device, a live image feed of the plurality of items;
displaying, via a user interface of the computing device, the grid filter over the live image feed of the plurality of items; and
capturing, at the computing device, the image of the plurality of items based at least in part on the plurality of items aligning with the respective segments of the plurality of segments, wherein the respective segments of the plurality of segments correspond to the respective image segments of the plurality of items.

5. The computer-implemented method of claim 4, further comprising displaying, via the user interface, feedback that indicates at least one item of the plurality of items fails to align with the respective segments of the plurality of segments.

6. The computer-implemented method of claim 1, further comprising:
receiving, at the computing device, the image of the plurality of items; and
displaying, via a user interface of the computing device, the grid filter over the image of the plurality of items, wherein segmenting the image of the plurality of items is responsive to the plurality of items aligning with the respective segments of the plurality of segments, and wherein the respective segments of the plurality of segments correspond to the respective image segments of the plurality of items.

7. The computer-implemented method of claim 1, wherein generating the at least one item listing comprises:
receiving, as output from a learning model and based at least in part on providing the image of the plurality of items as input to the learning model, one or more respective characteristics of the plurality of items and a measure of similarity between the one or more respective characteristics; and
generating, based at least in part on the measure of similarity between the one or more respective characteristics satisfying one or more threshold values, a single item listing for the plurality of items or respective item listings for the plurality of items, wherein one or more fields of the at least one item listing comprise the one or more respective characteristics of the plurality of items.

8. The computer-implemented method of claim 1, further comprising applying, based at least in part on a processing capability of the computing device and prior to generating the at least one item listing for the plurality of items, one or more image filters to the respective image segments, wherein the one or more image filters correct the respective image segments.

9. The computer-implemented method of claim 1, further comprising transmitting, based at least in part on a resolution of the image of the plurality of items, at least one of the respective image segments, the image of the plurality of items, or an indication of the grid filter to an application server for storage.

10. The computer-implemented method of claim 1, further comprising publishing, responsive to generating the at least one item listing, the at least one item listing via an application server.

11. The computer-implemented method of claim 1, wherein a numerical quantity of segments of the plurality of segments is based at least in part on an image resolution capability associated with the computing device and a threshold image resolution associated with the respective image segments.

12. A system comprising:
one or more processors; and
a computer-readable storage medium storing instructions that are executable by the one or more processors to perform operations comprising:
obtaining a selection of a grid filter comprising a plurality of segments to apply to an image of a plurality of items, wherein the plurality of items is associated with a same item category;
segmenting, based at least in part on the grid filter, the image of the plurality of items into respective image segments of the plurality of items, wherein respective items of the plurality of items align with respective segments of the plurality of segments; and
generating at least one item listing for the plurality of items, wherein the at least one item listing comprises at least one image segment of the respective image segments.

13. A computer-implemented method comprising:
transmitting, to a computing device, a plurality of grid filters to apply to an image of a plurality of items;
transmitting, based at least in part on transmitting the plurality of grid filters to the computing device, instructions to cause the computing device to select a grid filter from the plurality of grid filters, wherein a numerical quantity of segments of the grid filter is based at least in part on an image resolution capability associated with the computing device and a threshold image resolution associated with the image of the plurality of items; and
receiving, from the computing device and based at least in part on respective image segments of the image of the plurality of items, at least one item listing for the plurality of items wherein respective items of the plurality of items align with respective segments of a plurality of segments of the grid filter, and wherein the at least one item listing comprises at least one image segment of the respective image segments.

14. The computer-implemented method of claim 13, further comprising selecting the plurality of grid filters based at least in part on the threshold image resolution, wherein the threshold image resolution is associated with one or more of an image resolution capability associated with a learning model to generate the at least one item listing or a minimum resolution associated with the at least one item listing.

15. The computer-implemented method of claim 13, further comprising transmitting additional instructions to cause the computing device to display, via a user interface of the computing device, the grid filter over a live image feed of the plurality of items, wherein the image of the plurality of items is based at least in part on the plurality of items aligning with the respective segments of the plurality of segments, and wherein the respective segments of the plurality of segments correspond to the respective image segments of the plurality of items.

16. The computer-implemented method of claim 14, further comprising transmitting additional instructions to cause the computing device to display, via a user interface of the computing device, feedback that indicates at least one item of the plurality of items fails to align with the respective segments of the plurality of segments.

17. The computer-implemented method of claim 13, further comprising transmitting, to the computing device, the image of the plurality of items, wherein the plurality of items align with the respective segments of the plurality of segments, and wherein the respective segments of the plurality of segments correspond to the respective image segments of the plurality of items.

18. The computer-implemented method of claim 13, wherein receiving the at least one item listing is based at least in part on a measure of similarity between one or more respective characteristics of the plurality of items satisfying one or more threshold values, wherein the at least one item listing comprises a single item listing for the plurality of items or respective item listings for the plurality of items, and wherein one or more fields of the at least one item listing comprise the one or more respective characteristics of the plurality of items.

19. The computer-implemented method of claim 13, further comprising:
receiving, from the computing device and based at least in part on a resolution of the image of the plurality of items, at least one of the respective image segments, the image of the plurality of items, or an indication of the grid filter; and
storing the at least one of the respective image segments, the image of the plurality of items, or the indication of the grid filter.

20. The computer-implemented method of claim 13, further comprising publishing, responsive to receiving the at least one item listing, the at least one item listing.
